(19) United States
(12) Patent Application Publication
(10) Pub. No.: US 2008/0258885 A1
(43) Pub. Date: Oct. 23, 2008

(54) SYSTEM AND METHOD FOR RECORDING ENVIRONMENTAL DATA IN VEHICLES

(75) Inventor: Mehmet Bilgay AKHAN, Chamberlay (GB)

Correspondence Address: SAWYER LAW GROUP LLP, 2465 E. Bayshore Road, Suite No. 406, PALO ALTO, CA, 94303, US

(73) Assignee: SYNECTIC SYSTEMS GROUP LIMITED, SHEFFIELD (GB)

(21) Appl. No.: 12/105,612

(22) Filed: Apr. 18, 2008

Related U.S. Application Data
(60) Provisional application No. 60/912,895, filed on Apr. 19, 2007.

(51) Int. Cl. B60Q 1/00

(52) U.S. Cl. 340/425.5

(57) ABSTRACT

System and method for recording environmental accident data in vehicles. In one aspect, environmental data is received at inputs to a recorder device from a plurality of data sources in the vehicle. The environmental data is processed and indexed for recording onto a plurality of storage media. The environmental data is recorded onto the plurality of storage media such that each one of the storage media stores a same copy of at least a portion of the environmental data, wherein the environmental data is recorded before and after the accident of the vehicle.

### CROSS REFERENCE TO RELATED APPLICATIONS

This application claims the benefit of U.S. Provisional Application No. 60/912,895, filed Apr. 19, 2007, entitled, “System and Apparatus for Recording Vital Accident Data in Vehicles,” which is incorporated herein by reference in its entirety.

### FIELD OF THE INVENTION

The present invention relates to recording environmental data, and more particularly to recording environmental data during an accident of a vehicle.

### BACKGROUND OF THE INVENTION

Recording vehicular data during accidents or similar disasters is performed to help the determination of the causes of the accident. For example, vehicles such as aircraft, ships and trains may include ‘black box’ systems that record environmental data, such as the instrumentation data indicating the operating condition of the vehicle. Black box recorders are customarily designed to take various data inputs from the vehicle's instrumentation. The structure and design of a black box recorder is made rugged so that in the event of a vehicle crash or other mishap, the recorded data is protected and may later be analyzed. Currently this environmental data is usually restricted to specific vehicle operating data and rarely includes video and audio data.

In a non-air vehicle such as automobiles, trains, and sea craft, processing electronics will more often survive accidents. However, data needs to be written onto non-volatile solid state media and this media needs to be protected against an accident's adverse conditions.

Several types of data recorders have used in previous implementations. General Motors Inc. describes an Event Data Recorder (EDR) in its various publications and literature. The EDR only starts recording vehicular data in the event of a crash. This pattern of operation prevents EDR from recording data immediately before the crash. Furthermore, the recorded data is restricted to vehicular instrumentation data only, excluding recording of video and audio data. While the EDR has wireless connectivity, it is only used to send a distress signal. The EDR is not protected from severe accident conditions, fire, water and hazardous liquids.

In U.S. Pat. No. 6,795,759, a system and an apparatus is described for secure logging of vehicular data. The event data recorder offers a tamper proof sealing that prevents unauthorized access to the Event Data Recorder (EDR). The EDR can be removed after the accident, examined, and its contents read. If the tamper proof sealing is not broken, then the data can be presented to the authorities in the confidence that the data is not tampered with and genuine. However, the invention does not mention the sealing being proof against water, fire, or hazardous liquid, or being sufficiently robust to survive the accident conditions. Furthermore, the tamper proofing mechanism is limited to a physical sealing, and there is no hashing, signing, or encrypting of the data to reveal unauthorized attempts to access the data.

In U.S. Pat. No. 6,894,606, a vehicular black box system is described where processing images from strategically positioned video cameras around the vehicle allows identification of lane departure, vehicles coming too close, etc. Such data is also recorded for analysis after an accident. The recorded data may also be used for driver performance analysis. However, there is no mention of physical or electronic protection of storage media or recorded data.

In U.S. Pat. No. 6,246,933, a traffic accident recorder apparatus has a capability of capturing vehicle generated data and video from internal and external cameras. The traffic accident recorder is described as “small” to fit into any place in the vehicle. The recorder makes its data available after an accident, creating a video and data audit trail of events before and after the accident. However, the apparatus is not concerned with providing a rugged storage medium and making the data secure against unauthorized tampering.

Accordingly, a system and method for recording and preserving environmental data before and after an accident in vehicles, including protection from adverse accident conditions, unauthorized tampering, and inability to locate the data after the accident, would be desirable in many applications.

### SUMMARY OF THE INVENTION

The invention of the present application relates to recording vehicle environmental data during an accident of a vehicle. In one aspect of the invention, a method for recording environmental data during an accident of a vehicle includes receiving environmental data at inputs to a recorder device, the environmental data received from a plurality of data sources in the vehicle. The environmental data is processed and indexed for recording onto a plurality of storage media. The environmental data is recorded onto the plurality of storage media such that each one of the storage media stores a same copy of at least a portion of the environmental data, wherein the environmental data is recorded before and after the accident of the vehicle.

In another aspect of the invention, a recorder device for recording environmental data during an accident of a vehicle includes processing electronics receiving environmental data from a plurality of data sources in the vehicle and processing and indexing the environmental data for recording. A plurality of storage media is coupled to the processing electronics, where the processing electronics stores the environmental data onto the plurality of storage media such that each one of the storage media stores a same copy of at least a portion of the environmental data, and where the environmental data is recorded before and after the accident of the vehicle.

The invention provides a system and apparatus for capturing and recording environmental data onto multiple storage media before and after a vehicular accident such that multiple copies of the environmental data are recorded, ensuring that environmental data has a higher probability of surviving the accident. The environmental data can also be protected against accident conditions and unauthorized tampering. In addition, a radio locating device can be used to reliably locate the protected storage media after an accident.

### BRIEF DESCRIPTION OF THE FIGURES

FIG. 1 is a block diagram of one embodiment of a environmental data recorder of the present invention;

FIG. 2 is a diagrammatic illustration of a dual circular buffer recording scheme of the recorder of the present invention;

FIG. 3 is a diagrammatic illustration of the dual circular buffer recording scheme of FIG. 2, after an accident has been detected;

FIG. 4 is a flow diagram illustrating a method of the present invention for recording environmental data;

FIG. 5 is a flow diagram illustrating a method for generating authentication data for the environmental data recorder of the present invention;

FIG. 6 is a flow diagram illustrating a method for authenticating data read from the environmental data recorder 10 of the present invention;

FIG. 7 is a perspective view of a memory storage medium bonded with an RF tag radio device;

FIG. 8 is a diagrammatic illustration of a search after an accident for a storage medium of the recorder having a passive wireless detection device as shown in FIG. 7; and

FIG. 9 is a perspective view of an embodiment of the invention in which a storage medium is enclosed in an industrial-process rated enclosure and is attached to a main electronics board of the recorder.

### DETAILED DESCRIPTION

The present invention relates to recording environmental data, and more particularly to recording vehicle environmental data during an accident of a vehicle. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The present invention is mainly described in terms of particular components provided in particular implementations. However, one of ordinary skill in the art will readily recognize that this apparatus will operate effectively in other implementations and applications. For example, the systems usable with the present invention can take a number of different forms.

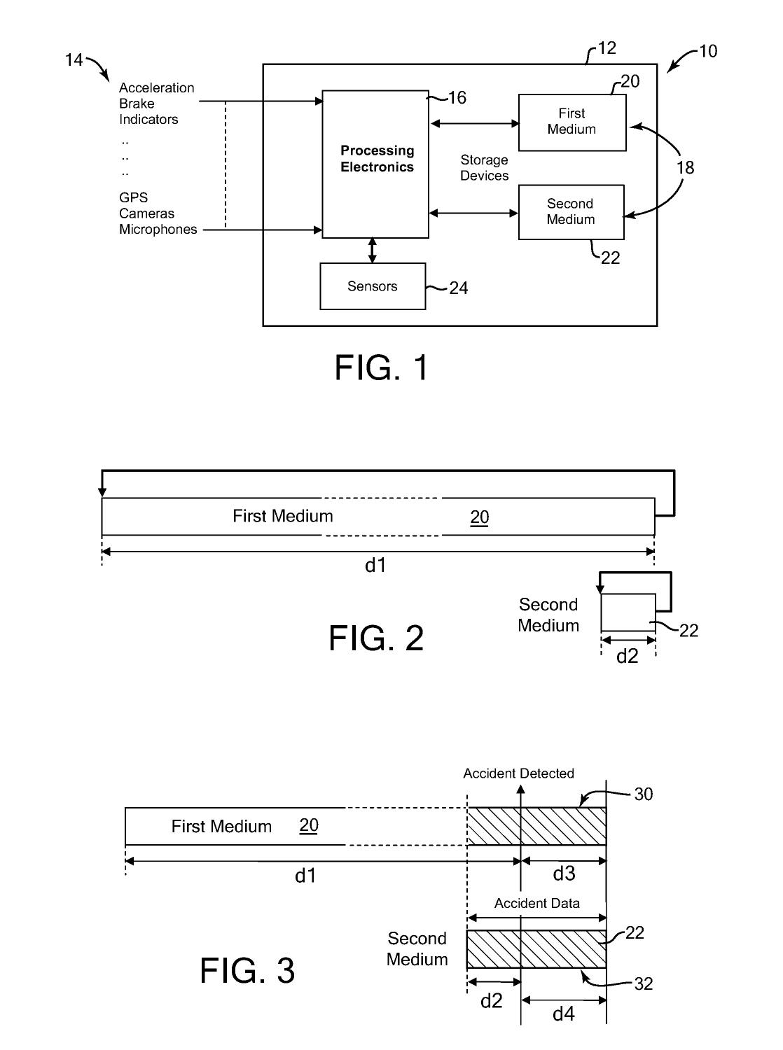

To more particularly describe the features of the present invention, please refer to FIGS. 1-9 in conjunction with the discussion below.

FIG. 1 is a block diagram of one embodiment of a environmental data recorder 10 of the present invention. The data recorder 10 can be provided in a vehicle or similar environment which may be subject to physical stresses or damage. For example, the data recorder can be located in an automobile, ship, military vehicle, airplane, helicopter, or other vehicle. Herein, any event which subjects the environment of the recorder 10 to such physical forces, damage, or stresses is referred to as an “accident.”

The data recorder 10 is provided with a rugged housing 12 that is designed to withstand extreme stresses and forces of an accident. For example, the housing 12 can withstand typical forces resulting from a crash of the vehicle in which the recorder is located.

A number of inputs 14 are provided to the recorder 10 from data sources while the vehicle is normally operating. The inputs provide “environmental data” describing the current environment in which the recorder 10 is located, from data sources such as vehicular systems. For example, such environmental data can describe current operating conditions of a vehicle, such as the current acceleration and velocity of the vehicle (e.g. using an accelerometer or velocity sensor), indications of when vehicle brakes are applied and in what degree they are applied, sensor data from sensors on the vehicle, data from an engine management unit describing current oil level, brake fluid level, engine temperature, or other system data, and signal inputs describing other systems of the vehicle (turn signals, door position, seat belts used or not, etc.). For example, many vehicles, sea craft and trains have a mechanism for generating signal data such as acceleration, braking, left & right indicators, seatbelt conditions, etc. as electronic signals. The recorder 10 can connect to such data sources.

In addition, in some embodiments additional sensors providing data not directly related to vehicular operating condition can be provided in the inputs 14 to the recorder 10. For example, images and/or video data from internal and/or external cameras mounted on or in the vehicle can be provided. Similarly, audio data from internal (e.g., inside the carriage) and/or external microphones can be provided. In addition, location data from Global Positioning System (GPS) sensors (indicating the location of the vehicle) can be input into the environmental data recorder 10. In many cases, visual and audio data can be crucial for establishing the exact circumstances and the reasons for an accident.

Vehicles have a number of data sources that make the driving-related environmental data available electronically. In some embodiments, the environmental data is supplied in analog form and digitally on a Controller Area Network (CAN) bus, and the digital data is input into the environmental data recorder 10. In other embodiments, some or all of the environmental data can be supplied in digital form. In other embodiments there can be more and different types of data inputs to the system.

The inputs 14 are provided to processing electronics 16 provided in the housing 12 of the recorder 10. Processing electronics 16 processes and indexes the input environmental data for storage, and writes the environmental data to the storage media of a number of storage devices 18 provided in the housing 12. The processing electronics 16 can also perform time and date generation as needed for recording data accurately. Processing electronics 16 can include well-known components for processing data and controlling other electronic components, such as one or more microprocessors, memory, interface electronics, etc.

The recorder 10 can be a totally autonomous apparatus; it need not be controlled by any signals or controllers of the vehicle or other environment. The recorder 10 can independently maintain and track the date and time, and in some embodiments can periodically update this date and time using, e.g., GPS sensed data.

The recorder 10 captures, indexes and stores (records) all of the input data 14, as shown in FIG. 1, onto at least two independent storage media that are accessible via one or more associated storage devices 18 (e.g., the electronics and mechanisms needed to read and write data for the storage media). Two storage media, first storage medium 20 and second storage medium 22, are shown in FIG. 1 (dual media), but in other embodiments more than two storage media can be used. The storage media 20 and 22 can be any of a variety of types of media; for example, in one described embodiment, first storage medium 20 can be a hard disk, while second storage medium 22 can be a flash memory card. Other types of storage media can be used for either medium 20 or 22, such as optical storage (CD, DVD, etc.), magnetic storage (magnetic tape, magnetic disk, etc.), memory (flash memory, EEPROM, etc.). The storage media are non-volatile so as to store the recorded indefinitely and be recoverable in the event of power loss to the recorder 10.

For example, the first storage medium 20 can be primary, longer term storage, while the second storage medium 22 can be secondary storage. The first medium 20 can be mechanical or silicon hard disk (e.g., Flash Technology), and may need to typically store data for long periods, e.g., days or weeks at a time. The secondary medium 22 can be solid state non-volatile memory, which only needs to hold data for a much shorter time, e.g., on the order of seconds or minutes. These features are described in greater detail below.

The present invention uses protected storage media to preserve recorded data in hazardous and adverse conditions. For example, the second medium 22 can be a small non-volatile memory device individually encapsulated in a protecting enclosure. The enclosure is designed such that it will protect the second medium 22 from the effects of fire, explosions, liquids and other adverse external effects, such that the medium 22 will survive most after accident conditions. In some embodiments, the first medium 20 need not be so (additionally) protected.

The recorder 10 can also include sensors 24 to sense the environment and detect accidents that occur to the environment in which the recorder 10 is located, such as vehicular crashes. For reliable accident detection, the sensors 24 can use a totally independent circuit that is not linked in any way with environment circuits, such as airbag deployment circuits or any other vehicle circuits. For example, sensors 24 can include a gravitational (G) sensor secured in the recorder 10 which in turn is secured to the body of the vehicle (or other environment feature). The G-sensor 24 can be a 3-axis (X, Y, Z axes) gravitational sensor used to detect and signal accidents. One type of G-sensor 24 suitable for recorder 10 is a CMOS-MEMS type of G-sensor, which can be built into an integrated circuit, e.g., the same chip as the processing electronics 16, or a separate chip. It is well-known how G-sensor signals can be analyzed to reliably and instantly detect vehicle accidents.

In another embodiment of the invention, the 3-axis G-sensor data recorded by G-sensor 24 may be used to deduce velocity, acceleration, deceleration, inclination, turning and other relevant environment data. The recorded gravitational data can be used as the sole source of evaluating vehicle velocity, deceleration and in some cases direction. The same recorded gravitational data may also be used for confirming the validity of vehicle-generated and vehicle-recorded data, as is well-known to those of skill in the art.

In other embodiments, additional or alternate types of sensors can be used to detect that an accident has occurred in the environment of recorder 10.

The recorder 10 may have access to both main environmental power (such as the power for the vehicle in which it is located), as well as its own, independent battery power. The recorder can use any power that is available at the time of an accident.

FIG. 2 is a diagrammatic illustration of a dual circular buffer recording scheme using an embodiment of the recorder 10 of the present invention. This circular data write operation to dual storage media is performed under normal, pre-accident conditions of the recorder environment. The recorder 10 writes data to the first storage medium 20 as well as the second storage medium 22, where both media 20 and 22 store a same copy of at least a portion of the received environmental data. The duplication in data on the media provides a greater chance that the environmental data will survive the stresses of an accident.

In this embodiment, environmental data is recorded onto the dual media 20 and 22 in a circular fashion. The first, longer term storage medium 20 typically stores and keeps the environmental data for a longer duration d1, such as one or more hours, days, or weeks. Recorded data is selectively off-loaded for examination and eventually overwritten, creating space for storing new environmental data as it is input at later times. The secondary storage medium 22 records data in much shorter cycles, each having a duration d2, and is periodically overwritten with new environmental data in a circular fashion, where at the beginning of each new cycle the data is started to be overwritten. For example, the duration d2 can be measured in seconds or minutes, e.g., 30 seconds in some embodiments. The second medium 22 thus stores a selected subset of the data written onto the first medium 20. Both the first and second media 20 and 22 also store other essential additional data for accident records.

During normal operation, storage medium 20 and storage medium 22 always hold the latest environmental data, where storage medium 20 stores more data that spans a longer time period, and storage medium 22 holds data spanning a much shorter period of time. In both cases, environmental data is overwritten cyclically and periodically. For example, as shown in FIG. 2, the data can be written sequentially in the storage space of each medium, and once the medium 20 or 22 is filled up and the end of the recording space is reached, the writing pointer returns to the beginning of the medium recording space and starts writing over the oldest data. Other embodiments may write data non-sequentially and track the order so as to overwrite the oldest data first.

The number of media that data is written to may be increased to three or more storage media, serving different purposes or for reasons of redundancy.

FIG. 3 is a diagrammatic illustration of a dual circular buffer recording scheme of the present invention, in which the write operation to dual storage media is performed in the event of an accident.

In response to an accident being sensed by the recorder 10, the recorder 10 changes its normal operation. The recorder 10 stops overwriting old environmental data and continues to write new data, preserving all of the data on both media. The new data (after the accident detection) is written on an accident storage area 30 of first medium 20 and on an accident storage portion 32 of second medium 22 for a duration of d3 and d4, respectively, as shown in FIG. 3. The accident storage areas 30 and 32 are not available for storing environmental data during normal operation, and are thus preserved for storing environmental data after an accident. In the described embodiment, both accident storage areas 30 and 32 provide sufficient storage space to record data for an equal period of time, i.e., d3=d4. In other embodiments, one storage area 30 or 32 can be larger than the other area 32 or 30 and thus record data for a longer period of time than the other area.

The amount of storage space in the accident storage areas 30 and 32 can be a predetermined amount that is considered sufficient to record events typically needed for a post-accident analysis of the data. For example, typically, the most important period after an accident to analyze is the first 60 seconds; thus, after an accident, the recorder 10 can record new environmental data for the first 60 seconds after the accident. Thus, examination of the second medium 22 after an accident can reveal 90 seconds of environmental incident data, including 30 seconds before the accident and 60 seconds after the accident. In other embodiments, a different time limit is used, based on a different amount of available storage space or other considerations. In some vehicle embodiments, the time limit can be based on a period of time beginning when the vehicle comes to a stop.

After the predetermined period d3 and d4 is expired, the recorder 10 can continue to record environmental data to both media 20 and 22 as long as possible (preserving all data), provided that the resources such as power supply, storage space, etc., are available for its operations. For example, additional reserved storage space can be provided after the storage space required for the predetermined durations d3 and d4, to store additional data. Typically, the recorder 10 includes a battery provision such that if the power supply from the environment is severed, the recorder 10 will continue to operate,

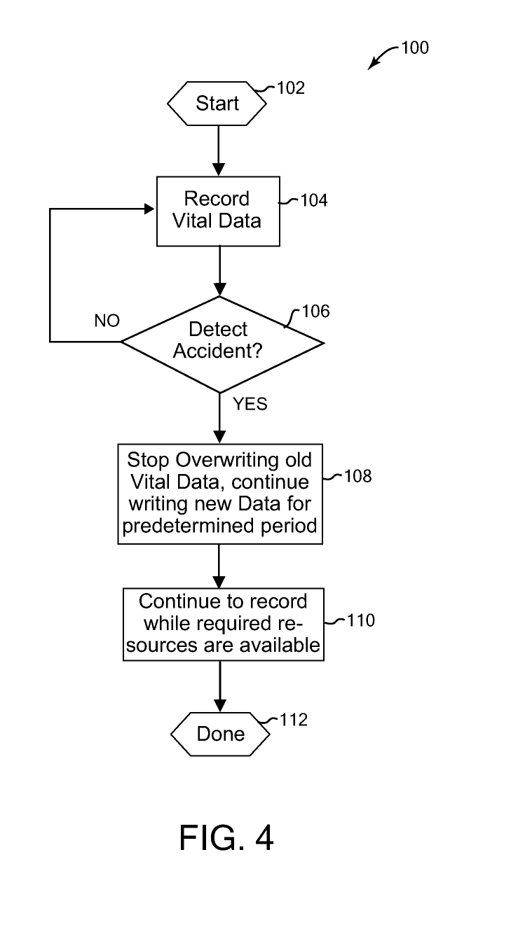

FIG. 4 is a flow diagram illustrating a method 100 of the present invention for recording environmental data. The method 100 can be implemented using the processing electronics 16 of the recorder 10, for example.

The method starts at 102, and in step 104, environmental data is recorded during normal operation of the environment in which the recorder 10 is located. In this normal operation, old environmental data, recorded previously, is overwritten when all storage space is filled on the media 20 or 22, as indicated above with respect to FIG. 2.

In step 106, it is checked whether an accident is detected. The accident can be detected by the recorder 10 in different ways in different embodiments. For example, sensors 24 of the recorder 10, such as the gravitational sensors described above, can be used to detect motion of the recorder or environment that indicates an accident has occurred. In other embodiments, sensors 24 can be external to the recorder 10 and can inform the recorder that an accident has occurred using one or more electronic signal inputs to the recorder 10.

If no accident has occurred, normal operation of the recorder continues at step 104. If an accident has occurred, then accident identification is signalled electronically to the necessary components of the recorder 10 (e.g., processing electronics 16), and in step 108, the recorder 10 starts environmental information recording with overwrite protection. The overwrite protection stops the overwriting of old data on the media 20 and 22. The recorder 10 continues writing new data on the media 20 and 22 for a predetermined period so as to preserve ail data. The predetermined period can be, for example, 60 seconds. For example, the data can be written linearly as described above with respect to FIG. 3. In step 110, the recorder continues to record environmental data, preserving all data, while the required resources are available. Such required resources include available storage space on the media 20 or 22, and the required power to continue recording.

The process is then complete at 112. The recorder 10 can be retrieved by other parties and its recorded data analyzed appropriately.

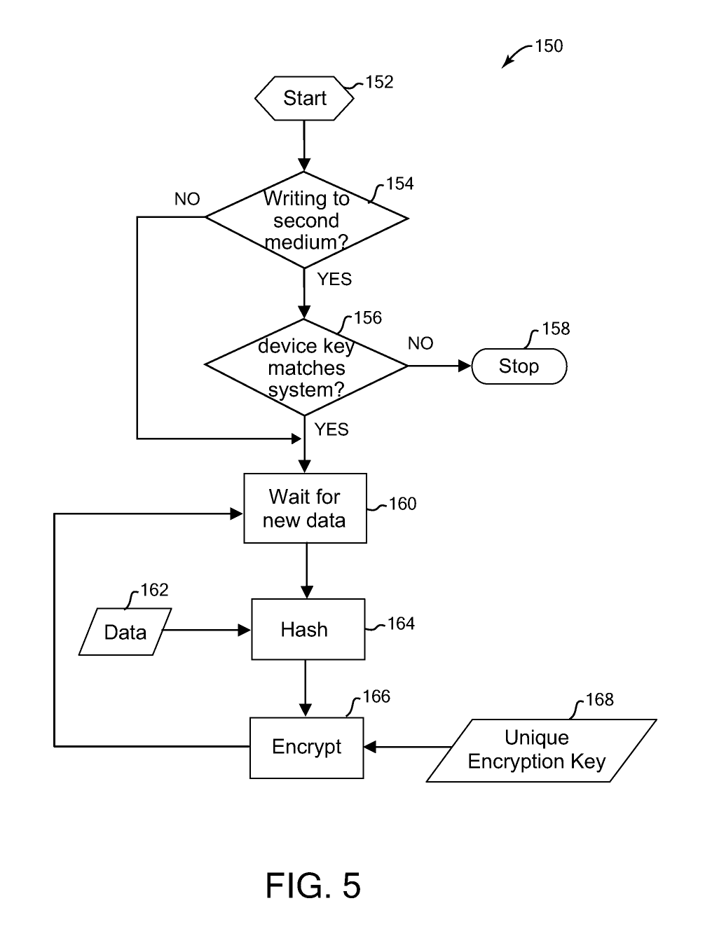

FIG. 5 is a flow diagram illustrating a method 150 for generating authentication data for the environmental data recorder 10 of the present invention. Some embodiments of the invention can include the creation of secure authentication strings for data to be written onto both first medium 20 and second medium 22. The authentication process of data writes to both the first medium 20 and second medium 22 makes the media data authenticable when read. This process ensures that the accident data is bona fide and is not tampered with in any way.

The method begins at 152, and in step 154, it is checked whether the data is to be written onto the second medium 22. The second medium 22 preferably has an additional layer of security for writes onto the medium 22, which is not needed for the first medium 20. Thus, if not writing to the second medium 22, the process continues to step 160, described below. If writing to the second medium, in next step 156 it is checked whether a device key matches the system on which the second medium 22 is being run or connected to. Second medium 22 has a unique device key associated with it (e.g., the device key can be stored on the medium 22 itself), and this device key is bonded to a particular system that is authorized to write to the medium 22, such that only the bonded system can achieve writes to the device. Thus, in step 156, it is checked whether the recorder 10 writing to the second medium 22 is the bonded system. If not, then the writing process is blocked at step 158.

If the system is authorized to write to the second medium 22, or if the first medium 20 is being written to, then in next step 160 the recorder system waits for new environmental data to record. At some point in time, environmental data 162 is received, and the data is hashed in step 164. In step 166, the resulting generated hash is encrypted using a recorder-specific encryption key 168, and stored (e.g., stored on the storage medium 20 or 22) or other storage in the recorder 10). A different encryption key is used for each recorder 10, each encryption key preferably being unique.

The recorder 10 also issues a ‘Read’ key at some point during the method 150 which enables decryption during a reading of the recorded data. It is not possible to use this Read key for encryption. For example, the Read key can be stored in an accessible location of recorder 10 which an authorized system will know where to find it, such as in a particular storage location on the media 20 or 22. The process then returns to step 160 to wait for new data to record.

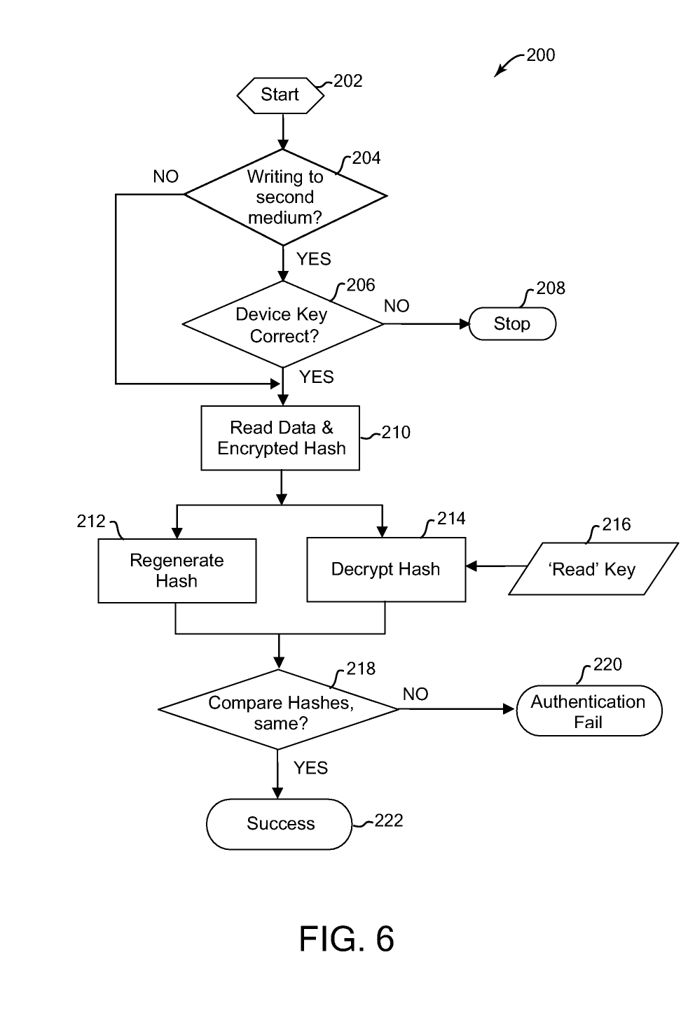

FIG. 6 is a flow diagram illustrating a method 200 for authenticating data read from the environmental data recorder 10 of the present invention. Method 200 reads and validates the authenticity of the read data. To retrieve accident data from the recorder 10, a host system must know the unique device key (for the second medium 22) as well as the Read decryption key.

The process begins at 202, and in step 204, it is checked whether the data is to be read from the second medium 22. The second medium 22 preferably has an additional layer of security for reading, which is not needed for the first medium 20. Thus, if not reading from the second medium 22, the process continues to step 210, described below. If reading from the second medium, in next step 206 it is checked whether the unique device key matches the system on which the second medium 22 is being run or connected to, i.e., whether the recorder system 10 reading from the second medium 22 is the bonded system matching the device key. (e.g., device key can be stored on the medium 22 itself). If not, then the reading process is blocked at step 208.

If the system is authorized to read from the second medium 22, or if the first medium 20 is being read, then in next step 210 the recorder system reads environmental data and the encrypted hash from the medium 20 or 22. In step 212, a hash is generated based on the read data, and in step 214 the retrieved hash from the medium 20 or 22 is decrypted using the Read key 216. In step 218, the generated hash is compared to the retrieved (decrypted) hash, and checked to see if they are the same. If not, the authentication has failed in step 220, and the data is considered unreliable and potentially tampered with. If the hashes are the same, then in step 222 there is success in authenticating the data and the data is considered bona fide and reliable.

FIG. 7 is a perspective view of a solid state non-volatile memory bonded with a radio device. In some embodiments of the invention, one of the media 20 or 22, such as the second medium 22, can be bonded with a passive RF device. In many cases it is very difficult to locate vital pieces of the vehicle after an accident, particularly small pieces. The present invention allows search parties to locate a storage medium storing the environmental data by using special radio transponders.

For example, as shown in FIG. 7, the passive RF device 250 is firmly bonded to a memory 252 which is an example of the second medium 22. The attachment can be facilitated by using a well-known industrial bonding process so that the passive RF device 250 will not be dislodged with high shock levels such as the ones associated with vehicle accidents.

The radio device 250 can, for example, be a passive Radio Frequency Identification (RFID) tag that consumes no power of its own. In the event of an accident, memory 252 may be dislodged from the housing of the recorder 10 or other housing in which it is normally situated, or may become entangled in accident rubble. In any case, a suitably designed radio transponder will be able to activate and find the memory 252 by sending the appropriate signal, which is received by the RFID tag and used to power the RFID tag so that it sends out an appropriate response, which is received by the radio transponder or other receiving device. In other embodiments, other types of passive wireless detection devices can be coupled to the second medium 22.

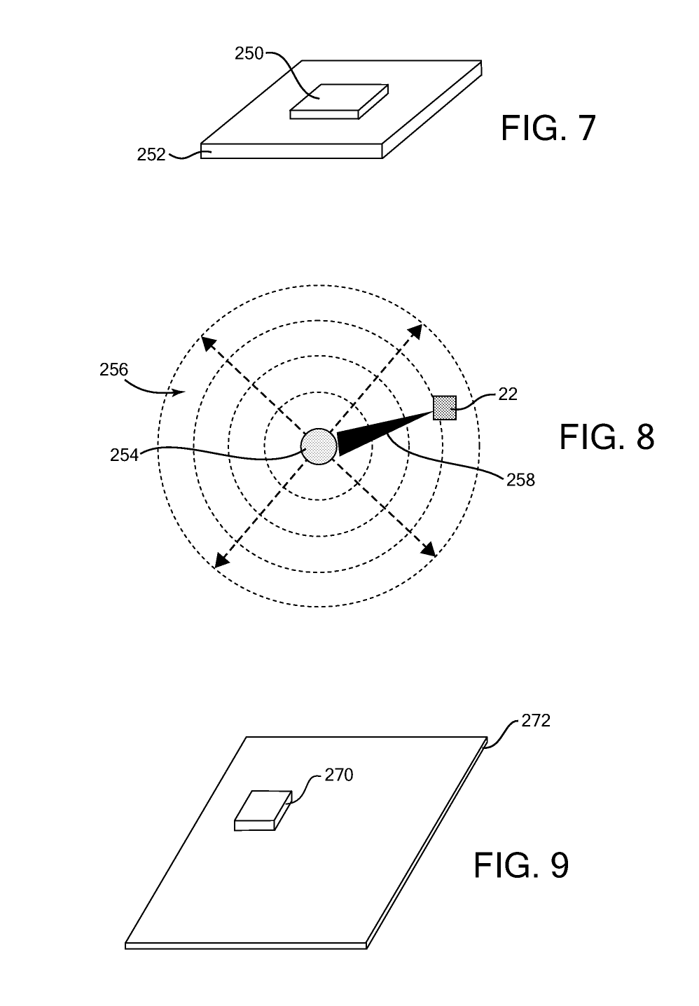

FIG. 8 is a diagrammatic illustration of a search after an accident for a storage medium of the recorder 10 having a passive wireless detection device as shown in FIG. 7. For example, medium 22 can be the memory 252 bonded to an RFID tag 250. The passive detection device makes it easier to locate the attached medium 22 in the case that the vehicle has disintegrated, for example, and dispersed the medium 22.

A radio transponder search device 254 is carried by a search party or accident investigators attempting to locate the second medium 22 after an accident has dispersed the medium 22 to an unknown location. The search device 254 transmits powerful radio signals at the correct frequency to cause a response from RFID tag 250 on the memory 22. If the RFID tag 250 of the second medium 22 is in sufficient proximity to receive the transmitted signals, e.g., within a particular range 256 between search device and RFID tag (such as 100 meters in some embodiments), the RFID tag can extract sufficient power from the radio signal and can transmit a signal response 258 back at a specific frequency, the signal being a series of binary digits forming a specific code. For example, the RFID tag 250 can identify itself with a unique device ID. On reception of this signal, the search device will be able to estimate the location of the second medium 22. By repeating the same search process several times, the search device 254 will be able to refine its homing process and locate the second medium 22 more accurately.

In another embodiment, a miniature active radio transmitter (and power source such as miniature battery) can be integrated with the second medium 22, instead of or in addition to a passive detection device. The transmitter is only activated after an accident. When the recorder 10 senses the accident, the active radio transmitter starts transmitting identifiable distress beacon signals periodically. These beacons, for example, can be a series of pre-determined digits sent as very short pulses periodically, e.g., every three minutes, at a predetermined transmission frequency. A search detection device carried by a searcher can sense the active transmissions when in range, to locate the second medium 22.

Using a radio locating system as described above can, in some embodiments, only be used for the second medium 22 and not for the first medium 20. In one embodiment, the first medium 20 can store more data but is relatively unprotected (except for the housing 12 of the recorder 10), and so is less likely to survive a severe enough accident that scatters it to an unknown location. The second medium 22, in contrast, can be individually protected much more strongly so that it can survive extreme accident conditions and survive being scattered long distances, in which case its locating system (and its more thorough security/authentication system, as described above) is more useful. Furthermore, strongly protecting only the smaller medium is more economical.

FIG. 9 is a perspective view of an embodiment of the invention in which the second medium 22 is enclosed in an industrial-process rated enclosure and is attached to a main electronics board of the recorder 10. The enclosed second medium 22 can be attached to the main electronics of the recorder 10 to form a “black box.”

The second storage medium 22 can be selected to be particularly robust against accident environments and severe shock, increasing the probability of operation under such conditions. Second medium 22 bonded with, for example, a passive radio detection device such as an RFID tag, can form an enclosure 270 which is fixed onto a main electronics board 272 of the recorder 10. The main electronics board 272 can include some or all of the processing electronics 16 and/or other electronics, such as for the storage media 20 and 22, sensors 24, etc. The second medium 22 can be molded with a suitable industrial process in a material that protects the second medium 22 against accident conditions, such as the effects of severe shock, water, fire and hazardous liquids.

In some embodiments, only the second medium 22 is protected against adverse conditions and not the entire recorder 10 system. This approach not only reduces cost, but it also makes the protection much more effective, as only a small physical piece need be protected. Experience shows that unlike aircraft accidents, non-aircraft vehicle accidents (automobile, sea craft, train, etc.) do not cause high fragmentation and spread of accident debris over large areas. Even in the case of on-vehicle bomb explosions, the spread of debris is limited to a few hundreds of meters as opposed to a few kilometers in the case of airplane crashes. Thus the passive RF device can allow locating the second medium 22 in such crashes with less spread distance. The industrial process used to mold and make second medium 22 protected against harsh conditions can be any of a variety of well-known processes. Such processes are widely available in industry.

The recorder device of the present invention uses multiple storage media writes, each medium storing a copy of at least a portion of environmental data, and thus ensuring that environmental data has a higher probability of surviving the accident. In one embodiment, the first medium can hold a higher volume of data and has minimal protection against accident conditions, while the second media can hold a smaller amount of data but has maximum protection against the most adverse accident conditions. Providing the most protection for only the smaller medium is more effective and economical. This dual path data recording combined with expected accident conditions creates an optimally safe data recording and protection system.

The invention can record vehicular data including video and audio data that may be available. The invention also can use methods to ensure that recorded data is authenticable after the accident making data validation possible. Furthermore, the invention can utilize a system for bonding radio devices to one of the multiple storage media, allowing a radio ranging method to be used to locate the protected storage media after an accident, which enables direct and easy finding of the data storage medium after the accident. Furthermore, the invention can use methods to mold an enclosure over the same data storage medium so that it is protected against environmental effects.

The different aspects of the disclosed apparatus and methods may be utilized in various combinations and/or independently. Furthermore, as used herein, the indefinite articles “a” and “an” connote to “one or more.”

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims. The invention covers all modifications, equivalents and alternatives falling within the spirit and scope of the invention as defined by the appended claims.

What is claimed is:

1. A method for recording environmental data during an accident of a vehicle, the method comprising:
receiving environmental data at inputs to a recorder device, the environmental data received from a plurality of data sources in the vehicle;
processing and indexing the environmental data for recording onto a plurality of storage media; and
recording the environmental data onto the plurality of storage media such that each one of the storage media stores a same copy of at least a portion of the environmental data, wherein the environmental data is recorded before and after the accident of the vehicle.

2. The method of claim 1 wherein the environmental data includes video data from cameras provided on the vehicle and audio data from microphones provided on the vehicle.

3. The method of claim 1 wherein the environmental data includes data from at least one of brakes, accelerometer, indicators, and seat belts of the vehicle.

4. The method of claim 1 wherein the environmental data includes engine data from an engine management unit of the vehicle, the engine data describing at least one of oil level, brake fluid level, and engine temperature.

5. The method of claim 1 wherein the recording the environmental data onto the plurality of storage media includes recording the environmental data onto a first storage medium and a second storage medium, and includes:
recording a larger amount of the environmental data onto the first storage medium; and
recording only a smaller amount of the environmental data onto the second storage medium, the second storage medium having less storage space than the first storage medium.

6. The method of claim 1 wherein the recording the environmental data onto the plurality of storage media includes recording the environmental data onto a first storage medium and a second storage medium, and includes:
recording a larger amount of the environmental data onto the first storage medium;
identifying and deleting the oldest recorded data on the first storage medium in response to reaching an end of storage space in the first storage medium;
recording only a smaller amount of the environmental data onto the second storage medium, the second storage medium having less storage space than the first storage medium; and
identifying and deleting the oldest recorded data on the second storage medium in response to reaching an end of storage space in the second storage medium.

7. The method of claim 6 wherein, in response to an accident of the vehicle being detected, the method includes:
continuing to record the environmental data onto the first storage medium and the second storage medium without deleting any of the recorded environmental data; and
stopping the recording onto the first and second storage media after a predetermined time period has elapsed after the accident.

8. The method of claim 1 further comprising providing an authentication mechanism the recorded environmental data, the authentication mechanism including:
creating a hash;
encrypting the hash using an encryption key associated with the recorder device;
recording the encrypted hash.

9. The method of claim 1 wherein a particular one of the storage media is associated with a device key, and wherein when writing the environmental data onto the particular storage medium, the writing is allowed only if the device key matches the recorder device.

10. The method of claim 8 further comprising reading the environmental data recorded on at least one of the plurality of storage media, wherein the reading includes authenticating the environmental data by decrypting the hash using a decryption key and comparing the decrypted hash with a generated hash.

11. The method of claim 1 wherein a particular one of the storage media is bonded to a radio device, the bond having sufficient strength such that the radio device will not be detached from the particular storage medium when exposed to high shock, hazardous substances, fire, and water, wherein the radio device enables the particular storage medium to be located after an accident using radio signals.

12. The method of claim 11 wherein the radio device is a passive RFID tag that is activated by a radio signal at a specific frequency, the RFID tag transmitting a specific code indicating an identity of the RFID tag in response to receiving the radio signal, wherein the RFID tag extracts necessary power from the received radio signal to respond.

13. The method of claim 1 wherein one of the storage media is bonded to an active radio device, the active radio device including a power source, wherein the active radio device is only activated after an accident of the vehicle, such that when an accident is signaled to the active radio device, the active radio device transmits beacon signals periodically.

14. The method of claim 1 wherein a particular one of the storage media is mounted with main processing electronics and is molded and encapsulated with special protective material such that the particular storage medium is waterproof, fire proof, and resistant to the effects of hazardous liquids and gases.

15. A recorder device for recording environmental data during an accident of a vehicle, the recorder device comprising:
processing electronics receiving environmental data from a plurality of data sources in the vehicle and processing and indexing the environmental data for recording; and
a plurality of storage media coupled to the processing electronics, wherein the processing electronics stores the environmental data onto the plurality of storage media such that each one of the storage media stores a same copy of at least a portion of the environmental data, and wherein the environmental data is recorded before and after the accident of the vehicle.

16. The recorder device of claim 15 wherein the environmental data includes:
data describing the operation of the vehicle; and
video data from cameras provided on the vehicle and audio data from microphones provided on the vehicle.

17. The recorder device of claim 15 wherein the plurality of storage media include a first storage medium and a second storage medium, wherein the first storage medium stores a larger amount of the environmental data and the second storage medium has less storage space than the first storage medium and stores a smaller amount of the environmental data than the first storage medium, and wherein the oldest recorded data on the first and second storage media are identified and deleted in response to reaching an end of storage space in the first and second storage media, respectively.

18. The recorder device of claim 17 wherein in response to an accident of the vehicle being detected, the processing electronics continues to write the environmental data onto the first storage medium and the second storage medium without deleting any of the recorded data, and the recording onto the first and second storage media is stopped after a predetermined time period has elapsed after the accident.

19. The recorder device of claim 15 further comprising a radio device bonded to a particular one of the storage media, the bond having sufficient strength such that the radio device will not be detached from the particular storage medium when exposed to high shock, hazardous substances, fire, and water, wherein die radio device enables the particular storage medium to be located after an accident using radio signals,

20. The recorder device of claim 19 wherein the radio device is a passive RFID tag that is activated by a radio signal at a specific frequency, the RFID tag transmitting an identity of the RFID tag in response to receiving the radio signal, wherein the RFID tag extracts necessary power from the received radio signal to respond,

21. The recorder device of claim 15 further comprising an active radio device bonded to a particular one of the storage media, the active radio device including a power source, wherein the active radio device is only activated after an accident of the vehicle, such that when an accident is signaled to the active radio device, the active radio device transmits beacon signals periodically.

22. The recorder device of claim 15 wherein a particular one of the storage media is mounted to the processing electronics and is molded and encapsulated with special protective material such that the particular storage medium is waterproof, fire proof, and resistant to the effects of hazardous liquids and gases.
